(19) United States
(12) Patent Application Publication
(10) Pub. No.: US 2014/0261696 A1
(43) Pub. Date: Sep. 18, 2014

(54) IN-LINE VALVE WITH IMPROVED FLOW

(71) Applicant: PHILIP SCHREIER, Simpsonville, SC (US)

(72) Inventor: PHILIP SCHREIER, Simpsonville, SC (US)

(21) Appl. No.: 13/804,835

(22) Filed: Mar. 14, 2013

(51) Int. Cl. F16K 31/06

(52) U.S. Cl. CPC F16K 31/06
USPC 137/1; 137/544; 251/129.15

(57) ABSTRACT

An improved in-line fluid valve for use with low pressure fluid sources containing pollutants.

### BACKGROUND

Valves are used in many applications wherein control of flow of a fluid is required or desired. This includes controlling the flow of includes such as oil, fuel, water, gases, etc. Some valves operate to control fluid flow by positioning valving members to control the amount of fluid allowed to pass through the valve. Other valves operate in a switching fashion wherein fluid flow is either turned on or turned off. Such valves may be found in consumer and commercial appliances such as dishwashers, washing machines, refrigerators, beverage vending machines, boilers, etc., whereby water is allowed to flow for a predetermined period of time or until a predetermined volume has been dispensed therethrough. The control of the valve operation may typically be performed by an electronic control circuit, such as a microprocessor based controller, along with its associated drive circuitry, to open and/or close the varying member within the valve.

A problem with such switching valves is the force necessary to open the valving member against the static pressure of the process fluid acting on one side of the valving member. Depending on the application, this pressure may be quite high, particularly when compared with the low pressure on the opposite side of the valving member which, in many appliance applications, is at atmospheric pressure. In addition to the static fluid pressure acting on the valving member tending to keep it closed, many such switching valves also include a spring positioned to apply a force on the valving member. This spring force allows the valve to be closed upon the removal of a drive signal, and maintains a bias force on the valving member to keep it closed.

In such configurations, the valve actuator must overcome both the force generated by the static fluid pressure, which can be quite high and may vary from installation to installation, as well as the spring force, both of which are acting to keep the valve closed. Once these two forces have been overcome, however, the force necessary to continue to open the valve to its fully open position is substantially reduced as the pressure differential across the valving member face drops dramatically. Once this pressure has been equalized, the only remaining force against which the actuator must act is the spring force.

Many electronically controlled switching valves include an electrically actuated solenoid to directly act on a plunger connected to the valving member to move the valving member to its open position. Unfortunately, due to the high pressure differentials that exist for a closed valve and the spring force, the actuator needs to be relatively large so that it is able to reliably operate the valve under all operating conditions and installations. In many industries, such as the consumer appliance industry, strict governmental and certifying agency requirements place a heavy premium on an electric power usage. Further, the appliance industry is highly competitive and the cost of actuators, alone or in addition to the production costs of the valve, provides a significant detriment to developing new technologies and implementing same in the industry.

One example of a prior art instrument for controlling fluid flow is illustrated by FIG. 1. FIG. 1 shows a water supply valve that includes a valve body 10 and an electromagnet unit 20. The valve body 10 includes a water inlet 11, a water outlet 12, and a chamber 14 between the water inlet 11 and the water outlet 12. The water inlet 11 is connected with the chamber 14 via a connecting passage 11a, and a valve seat 13 is provided in the central portion of the chamber 14.

The electromagnet unit 20 drives a first valve 15 to be attached to and detached from the valve seat 13 inside the chamber 14, so that the chamber 14 and the water outlet 12 are connected to and separated from each other. The first valve 15 also partitions the inside of the chamber 14 into the upper and lower sections, such that a pressure chamber 14 is defined in the upper section.

In addition, the first valve 15 includes a diaphragm 15a and a diaphragm holder 15b. The first valve 15 also has a first water passage 17 in the peripheral portion thereof beyond the valve seat 13, and a second water passage 18 in the central portion thereof. The first water passage 17 connects the chamber 14 with a pressure chamber 16, and the second water passage 18 connects the pressure chamber 16 with the water outlet 12.

In the first and second water passages 17 and 18, the second water passage 18 is opened and closed by a second valve 23 on the lower end of a plunger 22 that is installed inside the electromagnet unit 20 under a downward elastic force from a spring 21. Here, the first water passage 17 has an inner diameter smaller than that of the second water passage 18, and controls a flow of supply water following the opening and closing of the second water passage 18.

When power is not supplied to the electromagnet unit 20, the plunger 22 is brought into close contact with the valve seat 13 under its weight and the downward elastic force of the spring 21 and, at the same time, supply water supplied from the water inlet 11 pushes the first valve 15 upward instantaneously in the initial stage. This is because the elastic force of the spring 21, which presses the plunger 22, is smaller than supply water pressure.

However, the first valve 15, which is pushed upward, is directly closed by the supply water pressure. That is, right after water pressure is applied to the underside of the first valve 15, a portion of supply water is introduced into the pressure chamber 16 through the first water passage 17 in the first valve 15. The supply water introduced in this fashion applies a certain pressing force to the upper surface of the first valve 15 to bring the first valve 15 into close contact with the valve seat 13, thereby maintaining a closed circuit state. In this fashion, it is possible to achieve the closed circuit state that stops water supply without consuming electrical power.

In addition, when power is applied to the electromagnet unit 20, the plunger 22 of the electromagnet unit 20 is pushed upward, thereby opening the second water passage 18 of the first valve 15, which was closed by the second valve 23. At this time, the water in the pressure chamber 16 is caused to flow instantaneously toward the water outlet 12 under the atmospheric pressure through the second water passage 18, thereby dropping the pressure inside the pressure chamber 16 to the same as the atmospheric pressure. The force acting on the first valve 15 is released, so that the pressure of water supplied from the water inlet 11 causes the first valve 15 to drop to the upper surface of the valve seat 10. At the same time, a supply water passage passing through the water inlet 11, the chamber 14, and the water outlet 12 of the valve body 10 is maintained in the open circuit state, thereby achieving the intended water supply state.

In order to remove impurities from supply water, which passes through the power-saving electromagnetic water supply valve as described above, a filter 24 is necessarily provided adjacent to the water inlet 11. While the filter 24 prevents the first water passage 17 and the second water passage 18 from being clogged by the cohesion of impurities, these small particles becoming trapped in filter 24 significantly reduce the flow rate compared to an amount of introduced water. In addition, impurities accumulated in the filter increase resistance and thus water is not properly supplied.

Thus, valves such as valve 15 must be carefully engineered and sized to allow proper fluid flow from the inlet into the pressure chamber 16 in order to maintain the valve in a closed condition without requiring power input. This demands careful milling and/or injection molding and construction of the valve and the water passage 17. Moreover, any pollutants in the water source entering the inlet and passing the filter may clog water passage 17. This requires one to either clean or replace the valve in order to provide for keeping the valve in the closed state as blocking water passage 17 prevents equilibrium from establishing between the inlet and pressure chamber 16, instead forcing valve 15 open and causing a leak or further damaging the valve. Moreover, low water pressure could also impact the valve as the ambient pressure may be insufficient to either flow through water passage 17 or insufficient to move valve 15 once the plunger 22 is moved.

Valve construction is further complicated because not only does the static or atmospheric pressure of water systems vary across locations, as well as within a particular location, but pollutant levels also contribute to clogging and/or blocking valving mechanisms, thereby inhibiting their function and requiring frequent service calls to either unblock or replace units that no longer function. This problem is especially prevalent in areas that couple low fluid pressures, such as municipality provided water systems, with high pollutant content of the provided fluid.

What is needed in the art are environmentally friendly, low cost methods for allowing valving mechanisms to function in low pressure situations, especially in low pressure situations where the fluid being controlled contains pollutants.

### SUMMARY

Objects and advantages of the invention will be set forth in the following description, or may be obvious from the description, or may be learned through practice of the invention. It is intended that the invention include modifications and variations to the system and method embodiments described herein.

The present invention provides a fluid control mechanism that functions in low pressure fluid wherein the fluid may contain pollutants or detritus that would impede the function of previously known fluid control mechanisms or valves. In a particular embodiment, a fluid flow regulating mechanism is disclosed that includes an inlet and an outlet. The mechanism includes a divergence that divides an incoming fluid flow through the inlet into at least a control pathway and a flow pathway. A positionable member is located in the control pathway for selectively allowing fluid flow through the control pathway. A valve is positioned such that fluid flow through the control pathway prevents fluid from the flow pathway from exiting through the outlet until fluid pressure through the flow pathway exceeds fluid pressure through the control pathway. In a further embodiment, the divergence causes the control pathway to diverge at an angle from the flow pathway. In a still further embodiment, the divergence causes the control pathway to diverge at an angle between 0 and 90 degrees with respect to the flow pathway. In a still yet further embodiment, the divergence positions the control pathway and flow pathways generally parallel to one another. In another embodiment, cessation of fluid flow along the control pathway allows the flow pathway to displace the valve. In a yet further embodiment, no filtering mechanism is present in the inlet. The positionable member, in yet another embodiment, blocks either an inlet bore in the control pathway or outlet bore leading to the outlet. In a still further embodiment, a decrease in fluid pressure in the control pathway allows the flow pathway to open the valve. A further embodiment provides that an actuator causes the positionable member to move within the control pathway. In a still further embodiment, the actuator is a solenoid. An additional embodiment provides that the valve has a single opening while a still further embodiment discloses that the single opening is the outlet bore.

In another embodiment, a fluid flow regulating mechanism is disclosed that comprises an inlet and an outlet. A divergence divides an incoming fluid flow through the inlet into at least a control pathway and a flow pathway. A positionable member located in the control pathway influences pressure within the control pathway. A valve is positioned such that pressure in the control pathway prevents fluid from the flow pathway from exiting through the outlet until pressure is reduced in the control pathway.

In another embodiment, a method of regulating fluid flow is provided. An inlet and an outlet are provided. A divergence is established that divides the fluid stream into at least a control pathway and a flow pathway. A positionable member is placed in the control pathway to influence the fluid flow through the control pathway. A valve is positioned wherein the fluid flow entering the control pathway prevents the fluid flow from the flow pathway from exiting through the outlet until fluid flow has ceased entering the control pathway. In another embodiment, the divergence forms an angle between the control pathway and the flow pathway. In a still further embodiment, the divergence causes the control pathway to diverge at an angle between 15 and 75 degrees with respect to the flow pathway. In a further embodiment, cessation of fluid flow along the control pathway allows the flow pathway to displace the valve. Yet another embodiment provides that a decrease in fluid pressure in the control pathway allows the flow pathway to open the valve. An actuator, in another embodiment, causes the positionable member to move within the control pathway. A still further embodiment provides that the valve has a single opening. In a still further embodiment, no filtering mechanism is present in the inlet.

In a further embodiment, a water valve is disclosed. The valve includes a chamber defining an inlet and an outlet. An anchor may be disposed in the chamber and a pull element may be engaged with the anchor. A sealing cylinder is provided in the chamber that comprises a flow bypass channel, defined on an interior surface of the sealing cylinder. The sealing cylinder also defines an adjunct valve seat outlet, defined in an exterior surface of the sealing cylinder. A membrane is also included in the chamber and comprises a proximal surface toward the inlet and a distal surface facing away from the inlet. The membrane may also define a central cavity that engages an exterior portion of the sealing cylinder. In an anchor first position, the sealing cylinder may close a main valve seat defined in the chamber and water flows through the flow bypass channel to engage the distal surface of the membrane. In an anchor second position, displacement of the anchor moves the pull element distally away from the inlet to obstruct the flow bypass channel and opens the adjunct valve seat to allow water to flow through the adjunct valve seat and out the outlet. The anchor second position may lower water pressure on the distal membrane surface such that the membrane and sealing cylinder move distally away from the inlet to open the main valve seat such that water may exit the valve through the main valve seat and out the outlet. In another embodiment, the membrane may reposition by flexing distally from the inlet. Still further, the anchor may be displaced by an electromagnet. In another embodiment, the sealing cylinder includes a filter positioned substantially at a proximal end of the sealing cylinder. Still further, in the anchor second position, water flowing through the inlet out the main valve seat may engage the filter and remove debris from the filter. In another embodiment, the anchor engages a spring.

In another embodiment, a water control device is provided. The device comprises a chamber defining an inlet, an outlet, and a control cavity. An anchor may be disposed in the control cavity and a pull element may be engaged with the anchor. A sealing cylinder may be present and may comprise a flow bypass channel, defined on an interior surface of the sealing cylinder. The sealing cylinder may also define an adjunct valve seat outlet, defined in an proximal exterior surface of the sealing cylinder. A membrane may also be present in the chamber comprising a proximal surface facing toward the inlet and a distal surface facing away from the inlet. The membrane may define a centralized opening that may circumferentially engage an exterior portion of the sealing cylinder. In an anchor first position the sealing cylinder may close a main valve seat defined in the chamber and water flows through the flow bypass channel into the control cavity to engage the distal surface of the membrane. In an anchor second position, displacement of the anchor moves the pull element distally, away from the inlet, to obstruct the flow bypass channel, ceasing flow into the control cavity, and opens the adjunct valve seat outlet to allow water to flow from the control cavity through the adjunct valve seat outlet and out the outlet. The anchor second position lowers water pressure on the distal membrane surface such that the membrane and sealing cylinder move distally away from the inlet to open the main valve seat such that water may exit the valve through the main valve seat and out the outlet.

In a further embodiment, the membrane may reposition by flexing distally away from the inlet. Still further, the anchor may be displaced by an electromagnet. In a further embodiment, the sealing cylinder includes a filter positioned substantially at a proximal end of the sealing cylinder. Still further, in the anchor second position, water flowing through the inlet out the main valve seat engages the filter and removes debris from the filter. Even further, the anchor may engage a spring.

In another embodiment, a method of regulating fluid flow is disclosed. A chamber is provided that comprises an inlet and an outlet for a fluid stream. A first flow channel is established for the fluid stream through the inlet and into a control cavity. A positionable member may be placed in the control cavity to influence the fluid stream flow in the control cavity. A membrane and a sealing cylinder may be positioned in the chamber, wherein the membrane and sealing cylinder may be engaged with one another. The positional member may be positioned in a first position wherein the first flow channel entering the control cavity exerts pressure on the membrane and contributes to preventing the fluid stream from exiting through the outlet. The positional member may be positioned in a second position wherein the first flow channel has ceased to flow into the control chamber and the fluid stream exits as a second flow channel through the outlet via an exit outlet defined in an exterior of the sealing cylinder. When the anchor is in the positional member second position, the membrane may move distally from the inlet, such that the sealing chamber moves to block the second flow channel and opens a main valve seat to allow the fluid stream to exit from the inlet to the outlet as a third flow channel.

In a further embodiment, a filter may be positioned at the proximal end of the sealing chamber such that when the third flow channel is flowing, the third flow channel removes debris from the filter. In a still further embodiment, the membrane may reposition by flexing distally away from the inlet. Still further, the positional member may move from the first position to second position by being displaced by an electromagnet. Even further, the anchor may engage a spring.

Additional aspects of particular embodiments of the invention will be discussed below with reference to the appended figures.

### BRIEF DESCRIPTION OF THE DRAWINGS

A full and enabling disclosure, including the best mode thereof, to one of ordinary skill in the art, is set forth more particularly in the remainder of the specification, including reference to the accompanying Figures, in which:

FIG. 1 is an illustration of a prior art valve system.

FIG. 2 is an illustration of a preferred embodiment of the present disclosure.

FIG. 3A is an illustration of one embodiment of the present disclosure with the valve closed.

FIG. 3B is an illustration of one embodiment of the present disclosure with the anchor repositioned to the second position.

FIG. 3C is an illustration of one embodiment of the present disclosure with the valve carrier opening and the main valve seat open.

FIG. 3D shows a close-up view of FIG. 3C.

FIG. 4A shows a side view of one embodiment of a membrane that may be used with the present disclosure.

FIG. 4B shows a front down view of the membrane of FIG. 4A.

FIG. 4C illustrates a cross-sectional view of the membrane of FIG. 4A along line A-A of FIG. 4B.

FIG. 4D shows a tilted side view of the membrane of FIG. 4A.

FIG. 5A illustrates a bottom plan view of an alternative membrane design.

FIG. 5B illustrates a side profile view of the alternative membrane design of FIG. 5A.

FIG. 5C illustrates a top down plan view of the alternative membrane design of FIG. 5A.

FIG. 5D shows a profile cross section of FIG. 5C taken at line A-A.

FIG. 5E is a tilted view of the alternative membrane design.

FIG. 6 illustrates an alternative embodiment of the present disclosure.

FIG. 7A shows a side view of one embodiment of a holding nut that may be used with the present invention.

FIG. 7B shows a top down view of one embodiment of a holding nut.

FIG. 7C shows a cross sectional view of the holding nut of FIG. 7B at line A-A.

FIG. 7D shows a tilted view of the holding nut.

FIG. 8 shows a plan view of an alternative embodiment of a cylinder valve.

FIG. 9 is a cross sectional view of FIG. 8.

FIG. 10 is an exploded view of FIG. 8.

FIG. 11 is a cross sectional view of the cylinder valve of FIG. 10.

FIG. 12 is an angled plan view of a sealing cylinder.

FIG. 13 is a cross sectional view of the sealing cylinder shown in FIG. 12.

FIG. 14 illustrates a filter engaged with filter engaging surface of a sealing cylinder.

FIG. 15A illustrates one possible embodiment of a sealing pull element.

FIG. 15B shows a cross-sectional view of the sealing pull element of FIG. 15A.

FIG. 16 illustrates one embodiment of a sealing pull element engaged with a sealing cylinder.

FIG. 17A illustrates a cross-sectional view of one embodiment of a cylinder valve in a closed position.

FIG. 17B shows a magnified view of FIG. 17A.

FIG. 17C illustrates a cross-sectional view of one embodiment of a cylinder valve in a half open position.

FIG. 17D illustrates a cross-sectional view of one embodiment of a cylinder valve in a fully open position.

FIG. 18A illustrates a plan view of one embodiment for a membrane that may be employed in a cylinder valve.

FIG. 18B illustrates a cross-sectional view of the membrane of FIG. 18A.

FIG. 18C illustrates a plan view of another possible embodiment for a membrane.

FIG. 18D illustrates a cross-sectional view of the membrane of FIG. 18C.

FIG. 19A shows a plan view of one embodiment of a sleeve that may be used in a cylinder valve.

FIG. 19B shows a cross-sectional view of the sleeve of FIG. 19A.

FIG. 20 illustrates one possible embodiment of a housing for use with a cylinder valve.

### DETAILED DESCRIPTION

Reference will now be made in detail to various embodiments of the presently disclosed subject matter, one or more examples of which are set forth below. Each embodiment is provided by way of explanation, not limitation, of the subject matter. In fact, it will be apparent to those skilled in the art that various modifications and variations may be made to the present disclosure without departing from the scope or spirit of the disclosure. For instance, features illustrated or described as part of one embodiment, may be used in another embodiment to yield a still further embodiment. Thus, it is intended that the present disclosure cover such modifications and variations as come within the scope of the appended claims and their equivalents.

In general, the present disclosure is directed to a fluid control mechanism, such as an in-line fluid valve, for allowing greater efficiencies at low pressure volumes while not requiring the presence of a filter to screen pollutants from the incoming fluid.

In one embodiment, the present invention discloses a fluid control mechanism that functions in low pressure fluid wherein the fluid may contain pollutants or detritus that would impede the function of previously known fluid control mechanisms or valves. In a particular embodiment, a fluid flow regulating mechanism is disclosed that includes an inlet and an outlet. The fluid flow regulating mechanism may be formed from materials known to those of skill in the art such as plastics, polymers, metals, ceramics, etc., as well as combinations of the above.

The fluid flow regulating mechanism includes a divergence. The divergence may comprise a divider placed in the fluid flow to provide at least a control pathway and a flow pathway. The divergence may also comprise a passage or opening leading away from the fluid flow. The pathway may have a minimum diameter sufficient, as known to those of skill in the art, to accommodate a filter within the pathway. In a preferred embodiment, the divergence comprises an opening branching off or leading away from the incoming fluid flow. The divergence may be placed in the inlet or may be placed distal to the inlet with respect to fluid flow. In one embodiment, the divergence is placed upstream from the valve. In a further embodiment, the divergence is located near or adjacent to the proximal portion of the control pathway and is located at the proximal portion of the flow pathway. In a further embodiment, the divergence defines the proximal portion of the control pathway. In one embodiment, an inlet bore of the fluid flow regulating mechanism is smaller than the outlet bore of the fluid flow regulating mechanism.

In a preferred embodiment, the divergence causes the control pathway to diverge at an angle from the flow pathway. In a still further embodiment, the divergence causes the control pathway to diverge at an angle between 0 and 90 degrees. In another embodiment 15 and 75 degrees with respect to the flow pathway. In another embodiment, the angle of divergence is between 20 and 65 degrees. In a still further embodiment, the angle of divergence is between 30 and 55 degrees. In a preferred embodiment, the angle may be between 15 and 55 degrees. Importantly, the ranges of the present disclosure are provided for illustrative and informative purposes but should not be considered limited to the specified ranges as they may include combinations of the values specified for the above ranges, as well as values falling within these ranges such as, for purposes of example only, 22, 24, 26, 28, 30, 32, 34, 36, 38, 40, 42, 44, 55, 57, 60 and 72 degrees, etc.

A positionable member is located in the control pathway for influencing fluid flow through the control pathway. The positionable member may be a one-piece solid construct or formed from two or more pieces conjoined. The positionable member may be generally columnar in shape but may possess any shape known to those of skill in the fluid flow arts. In a preferred embodiment, the positionable member is positioned within a sleeve or tube and is movable between at least a first and second position. Movement may be effected by means as known to those of skill in the art including solenoids or other actuators used to encourage movement. The positionable member, in yet another embodiment, may block either an inlet bore in the control pathway or outlet bore leading to the outlet, depending on the position of the positionable member with respect to each bore.

A valve may be positioned in the fluid regulating member. Fluid flow through the control pathway prevents fluid from the flow pathway from exiting through the valve and then through the outlet until fluid has either ceased flowing through the control pathway or the flow has been reduced sufficient to allow the flow pathway to displace the valve. The valve may be formed from materials known to those of skill in the art and the valve may have multiple openings extending throughout its surface. These openings may be of various circumferences and shapes.

The pressure within the fluid regulating mechanism may influence the open and closed positions of the valve. In one embodiment, cessation of fluid flow along the control pathway allows the flow pathway to displace the valve. In other embodiments, reducing the pressure in the control pathway allows the valve to be displaced by the flow pathway.

In a preferred embodiment, no filtering mechanism is present in the inlet. However, filtering mechanisms may be placed throughout the device including in the control path or the flow path of the mechanism. Suitable filtering mechanisms include metallic or polymer meshes, nets, cups, seines, etc.

The current disclosure also includes methods and systems for regulating fluid flow.

Referring to FIG. 2, one embodiment of an in-line valve mechanism 200, pursuant to the present disclosure, is shown. In one embodiment, in-line valve mechanism 200 includes an inlet 202 by which a fluid, such as water, enters in-line valve mechanism 200. The inlet 202 may be formed or held in position by means such as a holding nut 204 or other means known to those of skill in the art. Means such as o-ring 206 may also be used to ensure a snug or tight fit between inlet 202 and the remainder of in-line valve mechanism 200 or, alternatively, inlet 202 may be formed integrally with the remainder of in-line valve mechanism 200.

Fluid passes from inlet 202 into flow tube 208 as well as into control fluid tube 210. Control fluid tube 210 is angled with respect to flow tube 208. This angle may vary as disclosed herein. Control fluid tube 210 may also include a small screen insert 212 that may serve to filter the fluid entering via inlet 202.

One benefit to the current disclosure is that when a filter 212, such as a small screen insert or other suitable filter as known to those of skill in the art, is employed, only a very small portion of the inlet water supply is filtered rather than filtering the entirety of the inlet water supply as with prior art designs. In one embodiment, filter 212 may be place at the entrance to control fluid tube 210 or within the body of control fluid tube 210. Suitable filters are commercially available and known to those of skill in the art.

In-line valve mechanism may also optionally include a terminal 220 in order to supply power to the in-line valve mechanism 200.

In-line valve mechanism 200 may also include a moveable anchor 222. The anchor 222 may be movably enclosed by a sleeve 224 and engage a spring 226, or other tensioning means as known to those of skill in the art. O-rings 227 and 229, or other suitable means as known to those of skill in the art, may be used to seal and/or sit anchor 222 within in-line valve mechanism 200. Anchor 222 may be positioned within sleeve 224 such that in a first position anchor 222 is distanced from an inlet bore 230 of control inlet 228 and an opposing end of anchor 222 engages and closes outlet bore 234 of control outlet 236. Anchor 222 may be movably fixed within sleeve 224 such that anchor 222 may slidably, or otherwise, as known to those of skill in the art, reposition within sleeve 224, such as for purposes of example only, through the interaction of a solenoid 232 and spring 226, and arrive at a second position wherein anchor 222 engages and closes inlet bore 230 of control inlet 228 and is distanced from outlet bore 234 of control outlet 236, thereby allowing fluid to pass through control passage 238.

As anchor 222 moves from the first to the second position, valve carrier 244 displaces with respect to seat 240 and moves from a closed position, when anchor 222 is engaging and closing outlet bore 234 of control outlet 236, to an open position when anchor 222 is engaging and closing inlet bore 230 of control inlet 228. This is due to the control inlet 228 being closed and the pressure differential exerted by the fluid passing through control passage 238 reducing to ambient pressure due to closing control inlet 228. Valve carrier 244 moves from a closed position to an open position due to fluid in flow tube 208 flowing from the flow tube 208 through flow outlet 242 into valve carrier area 246 and displacing valve carrier 244 from valve seat 240 due to the pressure differential now existing between the flow portion and control portion of in-line valve mechanism 200. Membrane 248 engages valve carrier 244. This may occur, such as for purposes of example only, by membrane 248 possessing an opening, not shown, that engages a perimeter of valve carrier 244. Alternatively, membrane 248 and valve carrier 244 may be of unitary configuration with the two, formerly described as separate, comprising a single structure. With valve carrier 244 moving in response to the fluid flow from flow outlet 242 flowing into valve carrier area 246, membrane 248, positioned between the valve carrier 244 and valve seat 240 moves from engaging valve seat 240 to being distanced therefrom. Thus, allowing fluid introduced by flow tube 208 into flow outlet 242 into valve carrier area 246 to exit the in-line valve mechanism 200 via outlet 250. Valve carrier area 246 may include a single opening from flow outlet 242 or may be designed such that flow from flow outlet 242 enters the valve carrier area 246 via more than one opening, such as two, three, four, six, or ten openings, although the disclosure should not be considered so limited and more or less openings may be used to encourage fluid flow from flow outlet 242 into valve carrier area 246.

The outlet 250 of in-line valve mechanism 200 may be sealed with an outlet sealing member 252. The outlet sealing member may constitute an o-ring, fluid seal, or other means as known to those of skill in the art.

In-line valve mechanism 200 may also include a solenoid 232, as known to those of skill in the art, that may include bobbin 214, which may be wrapped with a wire such as copper wire, or other suitable wrapping as known to those of skill in the art, to form coil 216 in association with a frame 218, wherein the frame may be steel, stainless steel, or another suitable material as known to those of skill in the art. Solenoid 232, or other actuating means as known to those of skill in the art, may be used to displace anchor 222 with respect to spring 226 in order to effectuate movement of anchor 222.

FIGS. 3A, 3B and 3C illustrate in-line valve mechanism 200 in its closed, opening, and opened positions, respectively. For instance, FIG. 3A shows the in-line valve mechanism 200 in a closed position. Fluid may enter inlet 300 but does not exit via outlet 302. Anchor 222 is positioned such that it is distanced from an inlet bore 230 of control inlet 228. In one embodiment, the diameter or inlet bore 230 may be smaller than the diameter of outlet bore 234 so that less fluid is capable of entering through inlet bore 230 than may exit through outlet bore 234. The positioning of anchor 222 may occur due to the elastic force of spring 226 and/or the force generated by the water pressure on the area of valve seat 240, or via other means known in the art. An opposing end of anchor 222 engages and closes outlet bore 234 of control outlet 236. Membrane 248 is positioned between the engaging surfaces of valve seat 240 and valve carrier 244 and in contact with both. Fluid, meanwhile, may flow into control passage 238, flow tube 208, as well as valve carrier area 246 but does enter outlet bore 234 nor exit outlet 302. In this position, the pressure in the control passage 238 and flow tube 208 are generally equal to one another.

FIG. 3B illustrates in-line valve mechanism 200 as the anchor 222 is actuated and moved from its initial position engaging and closing outlet bore 234 of control outlet 236 to engage inlet bore 230 of control inlet 228. As discussed herein, movement of anchor 222 may be effectuated via a solenoid 232 or via other means known in the art to overcome the force exerted by spring 226 and the force generated by the water pressure on the area of valve seat 240. This in turn causes anchor 222 to move from a first position to a second position as shown by FIG. 3B. The repositioning of anchor 222 closes inlet bore 230 and opens outlet bore 234 thereby providing access to control outlet 236. Due to the pressure differential between control passage 238 and control outlet 236, fluid begins to exit control passage 238 via control outlet 236 and flow from mechanism 200 via outlet 302. Meanwhile, valve seat 240 remains occluded by membrane 248 and valve carrier 244 due to the outflow pressure generated by the fluid exiting control passage 238 via control outlet 236. Thus, fluid flowing in flow tube 208 does not yet exit the mechanism 200 via outlet 302.

FIG. 3C illustrates in-line valve mechanism 200 as membrane 248 and valve carrier 244 are distanced from valve seat 240, thereby opening a passage to outlet 302. Valve seat 240 is now no longer occluded by valve carrier 244 or by membrane 248. Because flow through control passage 238 is prevented by anchor 222 closing inlet bore 230, the pressure in the control passage 238 is less than the pressure created by fluid entering inlet 300 and passing into flow tube 208 and may be at ambient pressure. Due to this pressure difference, the fluid introduced into valve carrier area 246 via flow tube 208 displaces valve carrier 244 and membrane 248 from valve seat 240 and prevents these from occluding valve seat 240. Thus, fluid from flow tube 208 now flows through and exits past valve seat 240 via outlet 302 as shown by arrows A. Meanwhile, the pressure of control passage 238 is at substantially ambient pressure and less than the pressure of flow tube 208 or valve carrier area 246.

In order to cease flow from flow tube 208, the force used to effectuate anchor 222 may simply be removed. Once removed, anchor 222 will reengage against outlet bore 234, as shown in FIG. 3A and force membrane 248 and valve carrier 244 back into engagement with valve seat 240. This prevents fluid from flow tube 208 from exiting past valve carrier 244 through the valve seat 240 and outlet 302.

FIG. 3D shows a close-up view of FIG. 3C showing the valve carrier 244 displaced from valve seat 240 thereby allowing fluid flow from flow outlet 242 through valve carrier area 246 to exit the fluid control mechanism past membrane 248 and valve carrier 244 via outlet 250. In addition to sealing off the diameter of outlet 250 in conjunction with valve carrier 244 and membrane 248, valve seat 240 serves to catch or receive membrane 248 when it is pushed toward valve seat 240 due to increased flow pressure or by activation of anchor 222. Thus, in a preferred embodiment, valve seat 240 is manufactured with a flat surface upon which membrane 248 rests without cutting, puncturing, tearing, or rupturing the material forming membrane 248. While valve seat 240 is described as having a flat engaging surface 241, engaging surface 241 may be curved or otherwise formed as known to those of skill in the art to prevent engaging surface 241 from damaging membrane 248.

Membrane 248 may serve various purposes in the fluid regulating member. For instance, it acts as a movable seal between the control and flow pathways. Thus, the membrane may function as a separator between the two hydraulic lines in the in-line valve. In one embodiment, when the flow of the control pathway is reduced, which may be as a result of moving the anchor away from the valve carrier, the pressure in the control pathway falls to near atmospheric levels. Meanwhile, the pressure exerted by the flow pathway increases. The force generated by the increased pressure in the flow pathway then lifts the membrane 248 to move valve carrier 244 away from valve seat 240 and engaging surface 241 to open a fluid pathway to outlet 250. The relative pressures exerted by pathways, via fluid or other means, serve to keep membrane 248 either open or closed, depending on which pathway exerts more pressure on membrane 248. Further, the membrane serves to create separate pressure chambers that may or may not have differing pressures depending on the action of the pathways in conjunction with the membrane. Additionally, membrane 248 serves to close off the valve seat 240 when engaged therewith.

Membrane 248 may come in various shapes. For instance, FIGS. 4A, 4B, 4C, and 4D show one possible embodiment of membrane 248. FIG. 4A shows a side view of one embodiment of membrane 248. FIG. 48 shows a front down view of one embodiment of membrane 248. FIG. 4C illustrates a cross-sectional view of FIG. 4B along line A-A. FIG. 4D shows a tilted side view of one embodiment of membrane 248. Membrane 248 may define a central cavity, in some embodiments, membrane 248 may only define a single opening or passage extending through membrane 248. In other embodiments, membrane 248 may contain additional openings aside from the central cavity. However, in a preferred embodiment, membrane 248 only defines a single passage extending through membrane 248. Membrane 248 may define a continuous, unbroken substantially radial surface surrounding and extending from a central cavity.

The material used to form membrane 248 should be sufficiently rigid in order to keep the valve closed but must be flexible enough to allow for repeated opening and closing of the valve as the pressure differential within the valve changes. Membrane 248 may be formed from various materials including rubber, synthetic resins, and polymers as known to those of skill in the art.

Membrane 248 may have an outer ring 402 as well as inner opening 404, see FIG. 4B. Outer ring 402 may serve to seal off the two pressure areas in the in line valve mechanism 200 created by the control and fluid pathways. Further, inner opening 404 engages with valve carrier 244 to hold and support the valve carrier 244 when membrane 248 is moved due to the differing pressures exerted by the control and flow pathways. While inner opening 404 is shown as round, the opening may be shaped in order to closely engage and or contact the lower surface of valve carrier 244, which may also be round or other shapes. Thus inner opening 404 may mate and engage with the shape of valve carrier 244 to provide a snug fit as well as to prevent leakage through inner opening 404. The engagement of inner opening 404 with valve carrier 244, as well as engagement of membrane 248 with engaging surface 241, coupled to the lack of open passages in membrane 248 (as inner opening 404 is filled by valve carrier 244) provides a much improved fluid differential over prior art devices.

This arrangement creates a generally absolute pressure differential versus the essentially relative pressure of prior art devices that possess open passages throughout, see FIG. 1, element 17, that allow fluid to freely flow throughout the valve mechanism. In the current disclosure, with membrane 248 sitting on or contacting engaging surface 241, actuation of opening membrane 248 is much improved due to the generally absolute pressure differential between the flow and control pathways. In contrast, the prior art requires a certain minimum pressure to overcome the force holding the prior art anchor in place.

FIGS. 5A-5E illustrate an alternative embodiment for a membrane 500. In this embodiment, membrane 500 provides a unitary construct with the membrane 500 forming the previously described membrane and valve carrier. As FIG. 5A illustrates, membrane 500 has an outer ring 502. However, the opening of membrane 500 is divided into multiple openings 504 for allowing fluid to exit through membrane 500 (once the anchor, not shown, is removed from engagement with the membrane 500 control bore 508). While only four openings 504 are shown, the disclosure should not be considered so limited and more or less openings may be provided. Inner opening 506, see FIG. 5C, provides access to the control bore 508 and through this to control outlet 510, see FIG. 5D.

FIG. 6 illustrates and alternative embodiment of an in-line valve mechanism 600. As FIG. 6 illustrates, in-line valve mechanism 600 discloses an inlet 602 leading to control pathway 604 and flow pathway 606 wherein the control pathway 604 and the flow pathway 606 diverge after inlet 602 and are generally parallel to one another. This embodiment provides an in-line valve mechanism that is simple to tool and form. While the size of control pathway 604 and flow pathway 606 may vary, the diameters of the pathways generally decrease along the respective flow pathways as they flow toward outlet 612. Other than the control pathway 604 and flow pathway 606 being in a generally parallel relationship to one another, in-line valve mechanism otherwise functions as the embodiments described supra.

In a further embodiment, the in-line valve mechanisms of the present disclosure may employ a holding nut 700 attached to or forming inlet 202 or 602. FIGS. 7A-7D illustrate one embodiment of holding nut 700. FIG. 7A illustrates holding nut 700 which includes perforations 702. Holding nut 700 may be made from rubber, synthetic resins, and polymers as known to those of skill in the art. Holding nut 700 may include an inlet 704 and an outlet 706. Holding nut 700 may also taper from inlet 704 to outlet 706 or the openings may be approximately the same size. FIG. 7B illustrates a top down view and shows holding nut 700 as comprising a generally circular side wall 708. FIG. 7C shows a cross-sectional view along line A-A of FIG. 7B. As FIG. 7C illustrates, attachment mechanism 710 may be used to affix holding nut 700 to the in-line valve mechanisms as described herein. While FIG. 7C shows attachment mechanism 710 as comprising threads, the disclosure is not so limited and other attachments means such as male/female couplings, slot and groove, snap-on or tabbed engagement, or other means of connecting nut 700, either temporarily or permanently, such as welding, adhesives, melt forming, etc., may be used as known to those of skill in the art. FIG. 7C also illustrates element 712. In one embodiment, element 712 is a slot or opening that extends though the body of holding nut 700 in order to allow access for a flat head screwdriver or other implement to assist with attaching and detaching attachment mechanism 710.

FIG. 8 shows a plan view of an alternative embodiment of a cylinder valve 800. Cylinder valve 800 includes a housing inlet 802, holding bracket 804, and housing outlet 806. Cylinder valve 800 may also include activator means 808, such as an electromagnet, for actuating an internal spring, not shown. Holding disc 810 is located distal from inlet 802 and maintains activator means 808, such as an electromagnet, in place with respect to the cylinder valve 800. Overmolding 812 may also be included along with terminals 814 for supplying power to cylinder valve 800. Cylinder valve 800, as well as inlet 802 and outlet 806, may be constructed from thermoplastics and metals.

FIG. 9 is a cross sectional view of cylinder valve 800. Cylinder valve 800 may include a seal such as flat seal 820. Flat seal 820, as well as any ring seal, ring seal rods, or membranes discussed herein, may be formed from rubber such as HNBR, NBR, or EPDM. Cylinder valve 800 may also include a filter 822 positioned within housing inlet 802 as well as a seal such as a piston or sealing pull element 824. Sealing pull element 824 may engage with anchor 826 and may function to seal off bypass 948, not shown. Sealing pull element 824 may be formed from various materials. In a preferred embodiment, sealing pull element 824 is formed from rubber as well, including HNBR, NBR, or EPDM. EPDM (ethylene propylene diene monomer rubber) is preferred because of its resistance to chlorine that may be present in water supplies.

Sealing pull element 824 may also be shaped to have a specific engagement geometry with anchor 826, such as male/female engagement, tongue in groove, twist engagement, or other specific geometries as known to those of skill in the art. An anchor 826 may be positioned distally from housing inlet 802. Anchor 826 may be actuated by means such as activator 808, this includes hydraulic activation, pneumatic, piezoelectric, electromagnetic, etc., or other means known to those of skill in the art, which in a preferred embodiment may be an electromagnet. Anchor 826 is preferably corrosion resistant and formed from magnetic steel. It slides within sleeve 834 and may have specific geometries on the surface that engages with sealing pull element 940, for instance, a round mating geometry may be formed, or other shapes as known to those of skill in the art. Anchor 826 may also include a flat surface for water bypass. A spring 828 may be placed circumferentially around anchor 826. A bobbin 830 may surround and enclose spring 828 and anchor 826. A coil 832 may circumferentially, or otherwise as known to those of skill in the art, engage bobbin 830 surrounding at least a portion of bobbin 830. Cylinder valve 800 may also include a sleeve 834. This sleeve may be of metal, plastic or other materials as known to those of skill in the art. Cylinder valve 800 may also include a membrane 836.

FIG. 10 is an exploded view of cylinder valve 800. Cylinder valve 800 may include a sealing cylinder 840. Membrane 842 may also be placed within cylinder valve 800 and engage sleeve 844 and circumferentially, or otherwise as known to those of skill in the art, engage sealing cylinder 840 by defining a cavity or other orifice that engages with the exterior of sealing cylinder 840. Sleeve 844 may include a tube 846 for containing anchor 826 and spring 828, both not shown. Sleeve 844 may be made from materials known to those of skill in the art including plastic, stainless steel, polymers, etc. Sleeve 844 may also include alignment feature 848, which may be used to align an electromagnet. Alignment feature 848 may be singular or multiple with one, two, three, four, five, six or more alignment features used to align an electromagnet. In a preferred embodiment, four alignment features 848 are present on sleeve 844. Cylinder valve 800 may also include at least one holding bracket 804, with two holding brackets 804 being preferred, to engage a holding plate 850. FIG. 11 is a cross sectional view of the cylinder valve 800 of FIG. 10.

FIG. 12 is an angled plan view of a sealing cylinder 840. Sealing cylinder 840 may include at least one small valve seat 860. Preferably, multiple small valve seat 860 are employed, including, two, three, four, five, six or more. Most preferably at least three small valve seats 860 are positioned equidistantly around the sealing surface 862 of sealing cylinder 840. At least one of the small valve seats 860 may define a passage to allow fluid to flow into the valve seat and out small valve seat outlet 866. Remaining small valve seats 860 are present to provide an even surface for sealing and do not define passages; however, in further embodiments, multiple passages may be defined by the valve seats including creating a separate passages that empty into a common outlet or individual passages that empty via separate outlets. Sealing cylinder 840 may also include a support ring 864 for membrane 842, not shown, as well as a small valve seat outlet 866. Small valve seat outlet 866 may be defined in the sealing cylinder 840 by drilling, mold forming, boring, pressing, etc., as known to those of skill in the art. Sealing cylinder 840 may also include engagement areas 868 and 870 for engaging, supporting and/or holding membrane 842.

FIG. 13 is a cross sectional view of sealing cylinder 840 shown in FIG. 12. As FIG. 13 illustrates, sealing cylinder 840 may include a bypass closing surface 900 as well as a filter engaging surface 902 and filter bosses 904. Small valve seat outlet 866 is shown as a right-angled passage defined within sealing cylinder 840. However, the disclosure is not so limited and may include other passage shapes such as curved, linear, circular, etc., as known to those of skill in the art. While multiple filter bosses 904 are shown in FIG. 13, sealing cylinder 840 may include three, four, five, six, or more filter bosses with six filter bosses 904 being preferred. Sealing cylinder 840 may also include a ring seal seat 906 for engaging a main valve seat, not shown.

FIG. 14 illustrates a filter 920 engaged with filter engaging surface 902 of sealing cylinder 840.

FIG. 15A illustrates one possible embodiment of a sealing pull element 940. Sealing pull element can be formed from various materials including rubber, plastics, polymers, etc. In a preferred element sealing pull element 940 is formed from rubber. Sealing pull element 940 includes a bypass closing surface interface 942. The bypass closing surface interface 942 serves to close the bypass, not shown, formed by sealing cylinder 840 when the interface 942 engages the interior of sealing cylinder 840 to close the bypass. The bypass may be closed from between 0% to 100%, including ranges therein such as 10-20%, 30-40%, 50-60%, 70-80%, and 90-100%, including individual figures disclosed within these ranges. FIG. 15B shows a cross-sectional view of the sealing pull element 940 of FIG. 15A. FIG. 15B illustrates that sealing pull element 940 may have various capture geometries 944 or shapes for engaging with an anchor 826, not shown. As FIG. 15B shows, the capture geometry 944 of the sealing pull element 940 may be ridged, curved, include flanges, grooves, struts, supports, or otherwise be formed to securely engage and/or hold an anchor 826, not shown, during functioning of the valve. This may include a male/female arrangement of corresponding structures or other mating of the capture geometry 944 and anchor 826 as known to those of skill in the art.

FIG. 16 illustrates one embodiment of a sealing pull element 940 engaged with sealing cylinder 840. Sealing pull element 940 is also engaged with anchor 826 via capture geometry 944. Also shown are small valve seat 860 defining a passage 861 to small valve seat outlet 866, not shown, and main valve seat engagement surface 946, which may include an O-ring or seal ring 947, as well as bypass 948, for allowing water to flow from the inlet, not shown, through filter 822, past sealing pull element 940 via bypass 948 and out sealing cylinder 840. Filter 822 is also shown.

FIGS. 17A, 17B, 17C, and 17D illustrate cross-sectional views of one embodiment of cylinder valve 800 in closed, a magnified-view closed, half-open and fully open positions, respectively. FIG. 17A illustrates one embodiment of cylinder valve 800 in the closed position. While closed, main valve seat 946 and small valve seat 860 are closed. Main valve seat 946 is closed by engagement with sealing cylinder 840 via flat seal 820 while small valve seat 860 is closed by engaging sealing pull element 940. Flat seal 820 may reside on the sealing cylinder 840 and seals main valve seat 946. Flat seal 820 may be formed from rubber, including but not limited to HNBR, NBR, and EPDM. Flat seal 820 may be formed to create an inner connection to the sealing cylinder 840 with another surface contacting main valve seat 946. As flow arrow A illustrates, in this configuration, water flows into the inlet 802, passes through filter 920 continues through sealing cylinder 840 then through bypass 948. Water pressure, illustrated by the backward curving side arrows of A shows that the water pressure on the distal surface, the surface facing away from the inlet, of membrane 842 maintains sealing cylinder 840 in contact with the main valve seat 946. Water pressure shown by flow arrow A and the pressure exerted by spring 828 serve to force anchor 826 against small valve seat 860. Spring 828 is preferably corrosion resistant with a spring rate of 0.015 N/mm. Essentially, the maximum spring force combined with the force generated by water pressure on the small valve seat 946 may be smaller than the force of the activator 808. Spring 828 serves to hold anchor 826, and via this, sealing cylinder 840, against main valve seat 946. In one embodiment, cylinder valve 800 may include a piston 801 that engages anchor 826 through a cavity or hole 803, not shown, formed in anchor 826. Piston 801 may be affixed to anchor 826 through various means, including welding, frictional engagement, adhesives, etc. In one embodiment, piston 801 may be ultrasonically welded to anchor 826. Piston 801 may form, hold, or engage sealing pull element 824 which engages and seals bypass 948.

FIG. 17B shows a magnified view of FIG. 17A showing main valve seat 946 closed, bypass 948 open, small valve seat 860 closed, and membrane 842 under pressure from water flowing into housing inlet 802 through filter 920. In this view, water or fluid would pass through bypass 948 while no fluid would enter small valve seat 860 or exit small valve seat outlet 866.

FIG. 17C illustrates one embodiment of cylinder valve 800 in a half open position. In this configuration, main valve seat 946 is closed, bypass 948 is closed, and small valve seat 860 is open. Movement of anchor 826 and sealing pull element 940, effectuated by electromagnetic or other known actuator means 808, closes bypass 948 by engaging bypass closing surface interface 942 with the opening of bypass 948 to seal the bypass 948. In this half-open configuration, pressure on the distal face 843, facing away from the inlet, of membrane 842 is lowered by allowing water, shown by flow arrow B, flowing through housing inlet 802 to flow through filter 920 and exert pressure on the proximal, inlet facing, surface 841 of sealing cylinder 840 due to bypass 948 being closed by sealing pull element 940. Further, water or fluid beyond the now closed bypass 948 flows through, now open, small valve seat 860, shown by flow arrow C, then through small valve seat outlet 866 and eventually exits via housing outlet 806 as shown via flow arrow D.

FIG. 17D illustrates one embodiment of cylinder valve 800 in a fully open position. In the fully open configuration, main valve seat 946 is open, bypass 948 is closed, and small valve seat 860 is open while small valve seat outlet 866 is closed. Water pressure on the distal face 843 of membrane 842 is below the pressure of water flowing into housing inlet 802. In this configuration, water flowing into inlet 802, illustrated by flow arrow E, flows past filter 920, as shown by flow arrow F, thereby flushing debris and detritus from the filter, not shown, and exits cylinder valve 800 via housing outlet 806, shown via flow arrow G.

As FIGS. 17A-17D illustrate, in one embodiment, cylinder valve 800 uses water pressure to keep the valve closed via pressure on the distal face 843 of membrane 842. After opening the small valve seat 860, pressure on the distal face 843 of membrane 842 is lowered and this assists with opening main valve seat 946 by allowing the membrane 842 to reposition, shown in FIG. 17D. This repositioning may occur due to flexing of membrane 842 in a distal direction away from inlet 802 due to the combined actions of anchor 826 moving distally and the water pressure exerted on the proximal face 841 or sealing cylinder 840. This arrangement is especially useful in low pressure and/or polluted water systems where the hydraulic difference/water pressure differential inside the valve between the flow arrangement, such as the inlet, and control arrangement, membrane 842, sealing pull element 948, and anchor 826, is not large. Prior art valves in low pressure/polluted systems would exhibit low flow rates at low pressures, primarily due to the valve seat not fully opening due to the low inlet pressure not offsetting the counteracting pressure already present within the prior art valve. In the current disclosure, when anchor 826 is attracted by a magnetic field, or other motivating force as known to those of skill in the art, the force exerted on anchor 826 overcomes the water pressure force exerted on small valve seat 860 as well as the force exerted by spring 828. After a short stroke, the geometry of sealing pull element 940 closes bypass 948 either completely or partially. This eliminates or reduces water flow to the control chamber 850. Thus, the water pressure in control chamber 850 becomes less than water the water pressure introduced by housing inlet 802 as water exits the control chamber 850 through small valve seat outlet 866 and housing outlet 806. Further, by capturing sealing pull element 940 via engagement of the bypass closing surface interface 942 and bypass 948, anchor 826 pulls sealing cylinder 840 and supports further opening of main valve seat 946 as both the anchor 826 and in flowing water pressure exert pressure on sealing cylinder 840 to move it distally from inlet 802. Another advantage of the present disclosure is that there is no need for a complete filtering system. Filter 822 or 920 filters only water passing into control chamber 850. Further, when main valve seat 946 is opened, water flowing past filter 822 or 920 will wash or flush dirt and debris from filter 822 or 920 and introduce same into flow stream F which will wash the dirt and debris via flow stream G out of the valve 800 through housing outlet 806. This generates a self-cleaning valve assembly especially suited for polluted or low flow water pressure systems that removes dirt and debris from filter 822 or 920 when main valve seat 946 is open. Thus, the flow rate through cylinder valve 800 may stay continuous over the lifetime of the valve and service calls will not be necessary to remove or replace debris filled filters. In addition, the present disclosure can result in smaller sized valves that consume less materials in their construction.

FIGS. 18A and 18B illustrate one embodiment for a membrane 960 that may be employed in cylinder valve 800. While FIGS. 18A and 18B illustrate membrane 960 as having a generally circular appearance, the membrane may be shaped in any manner known to those of skill in the art in order to fit and function within cylinder valve 800, this includes but is not limited to oblong, ellipses, squares, rectangles, triangles, polygons, etc. The membrane may be constructed from suitable flexible materials, including but not limited to rubbers, silicones, neoprenes, etc. Membrane 960 preferably is flexible to accommodate shifts in position during use in cylinder valve 800 under with the influence of anchor 826, water pressure, or both. As FIG. 18A illustrates, membrane 960 may have specifically shaped sealing geometries for engaging sealing chamber 840, membrane sealing chamber geometry 962, as well as geometries for engaging sleeve 834, membrane sleeve geometry 964. These sealing geometries render membrane 860 impervious to water flowing through the membrane as well as ensure a water-tight engagement between membrane 960 and sleeve 834 as well as sealing cylinder 840. Membrane 960 is free from openings that would allow water to through the membrane 960. Membrane 960 may also have sleeve engagement features 966 for engaging sleeve 834. While FIG. 18A illustrates six sleeve engagement features 966, the disclosure is not so limited and more or less sleeve engagement features 966 may be present ranging from one continuous engagement feature to separated features having one, two, three, four, five, six, or more separate sleeve engagement features 966. Membrane 960 should also be able to withstand pressure. For instance, in a preferred embodiment membrane 960 should be able to withstand a pressure of 24 bar, but lower and higher pressures are also included in this disclosure. For instance, membrane 960 should be able to withstand pressures ranging between 0-24 bar, including ranges therein such as 0-5 bar, 5-10 bar, 15-20 bar, and 20-24 bar, including individual pressures contained therein. Membrane 960 serves seal the housing 980, not shown, and may include further geometry for locking or engaging with bobbin 830. Membrane 960 may also be formed with engagements such as 966 to lock the membrane into engagement with connecting members. Membrane 960 may also include a pressure ring 961 for engaging with sealing cylinder 840 via inner connection 963. FIG. 18B is a cross sectional view of FIG. 18A and shows proximal surface 845 (inlet facing) and distal surface 843 (facing away from the inlet). A further advantage of the present disclosure is that the “water hammer” effect sometimes present while closing a valve is reduced due to the flexibility of the membrane during short pressure peaks.

FIG. 18C illustrates an alternative embodiment of membrane 1000 that may be employed in the present disclosure. Membrane 1000 includes engagement members 1002 for locking membrane 1000 in place with opposing connecting members, not shown. Membrane 1000 also includes pressure ring 1004 for engaging with sealing cylinder 840 via pressure or frictional engagement. Membrane 1000 has a distal surface 1006 and a proximal surface 1008. Membrane 1000 also includes raised protrusions 1010 that help prevent sticking or adhering between membrane 1000 and any features in the valve that may come into contact with membrane 1000 in either its “relaxed” position in the anchor first position or its “flexed” configuration in the anchor third position or for positions between these two. FIG. 18D illustrates a cross-sectional view of membrane 1000 of FIG. 18C.

FIG. 19A shows one embodiment of a sleeve 834 that may be used in cylinder valve 800. Sleeve 834 may include a tube 970 for containing anchor 826 and spring 828. Sleeve 834 also includes a sealing surface 972 for sealing off the outer diameter of membrane 960 or 842. Sleeve 834 may also include a housing engagement surface 974 for holding sleeve 834 within cylinder valve 800, FIG. 19B is a cross section view of FIG. 19A. FIG. 19B illustrates that sleeve 834 may include contact surface 976 for engaging with membrane 842 or 960. Sleeve 834 also includes anchor gliding surface 978. Sleeve 834 may be formed from various materials including non-magnetic metals, stainless steel, thermoplastics, etc., as known to those of skill in the art. In a preferred embodiment, sleeve 834 is constructed from stainless steel. The steel may have a thickness ranging from 0.1 mm to 1 mm, including 0.2, 0.3, 0.4, 0.5, 0.6, 0.7, 0.8, and 0.9 mm, including ranges formed between these figures. In a preferred embodiment, sleeve 834 has a thickness of 0.3 mm.

FIG. 20 illustrates one possible embodiment of a housing 980 for use with cylinder valve 800. FIG. 20 illustrates the location of main valve seat 946 as well as sleeve holding surface 982 and membrane sealing surface 984 for sealing off the outer diameter of membrane 842 or 960.

While the anchor is described by the term “position” with respect to various of the FIGURES, those of skill in the art will recognize that a multitude, or range, of positions are possible as described herein based on the disclosure pertaining to a respective figure of a particular anchor “position.” The disclosure should not be considered or limited to anchor as disposed statically or rigidly or in a particular fixed position via the positions illustrated in the figures, unless so indicated in the description. Variations and various placements of the anchor may accomplish the results described in each of the figures and multiple such positions are not only possible but are herein fully supported and disclosed as would be recognized by those of skill in the art.

While the subject matter has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present disclosure should be assessed as that of the appended claims and any equivalents thereto.

What is claimed is:

1. A water valve comprising:
a chamber defining an inlet and an outlet;
an anchor disposed in the chamber;
a pull element engaged with the anchor;
a sealing cylinder comprising a flow bypass channel, defined on an interior surface of the sealing cylinder, the sealing cylinder also defining an adjunct valve seat outlet, defined in an exterior surface of the sealing cylinder;
a membrane with a proximal surface toward the inlet and a distal surface facing away from the inlet;
the membrane defining a central cavity, the membrane central cavity circumferentially engaging an exterior portion of the sealing cylinder;
in an anchor first position the sealing cylinder closes a main valve seat defined in the chamber and water flows through the flow bypass channel to engage the distal surface of the membrane;
in an anchor second position, displacement of the anchor moves the pull element distally to obstruct the flow bypass channel and opens the adjunct valve seat to allow water to flow through the adjunct valve seat and out the outlet; and
the anchor second position lowers water pressure on the distal membrane surface such that the membrane and sealing cylinder move distally from the inlet to open the main valve seat such that water may exit the valve through the main valve seat and out the outlet.

2. The water valve of claim 1, wherein the membrane repositions by flexing distally from the inlet.

3. The water valve of claim 1, wherein the anchor is displaced by an electromagnet.

4. The water valve of claim 1, wherein the sealing cylinder includes a filter positioned substantially at a proximal end of the sealing cylinder.

5. The water valve of claim 5, wherein in the anchor second position, water flowing through the inlet out the main valve seat engages the filter and removes debris from the filter.

6. The water valve of claim 1, wherein the anchor engages a spring.

7. A water control device comprising:
a chamber defining an inlet, an outlet, and a control cavity;
an anchor disposed in the control cavity;
a pull element engaged with the anchor;
a sealing cylinder comprising a flow bypass channel, defined on an interior surface of the sealing cylinder, the sealing cylinder also defining an adjunct valve seat outlet, defined in an proximal exterior surface of the sealing cylinder;
a membrane with a proximal surface and a distal surface;
the membrane defining a centralized opening, the membrane centralized opening circumferentially engaging an exterior portion of the sealing cylinder;
in an anchor first position the sealing cylinder closes a main valve seat defined in the chamber and water flows through the flow bypass channel into the control cavity to engage the distal surface of the membrane;
in an anchor second position, displacement of the anchor moves the pull element distally to obstruct the flow bypass channel, ceasing flow into the control cavity, and opens the adjunct valve seat outlet to allow water to flow from the control cavity through the adjunct valve seat outlet and out the outlet; and
the anchor second position lowers water pressure on the distal membrane surface such that the membrane and sealing cylinder move distally from the inlet to open the main valve seat such that water may exit the valve through the main valve seat and out the outlet.

8. The water valve of claim 7, wherein the membrane repositions by flexing distally away from the inlet.

9. The water valve of claim 7, wherein the anchor is displaced by an electromagnet.

10. The water valve of claim 7, wherein the sealing cylinder includes a filter positioned substantially at a proximal end of the sealing cylinder.

11. The water valve of claim 10, wherein in the anchor second position, water flowing through the inlet out the main valve seat engages the filter and removes debris from the filter.

12. The water valve of claim 1, wherein the anchor engages a spring.

13. A method of regulating fluid flow comprising:
providing a chamber with an inlet and an outlet for a fluid stream;
establishing a first flow channel for the fluid stream through the inlet and into a control cavity;
placing a positionable member in the control cavity to influence the fluid stream flow in the control cavity;
positioning a membrane and a sealing cylinder in the chamber, wherein the membrane and sealing cylinder are engaged with one another;
positioning the positional member in a first position wherein the first flow channel entering the control cavity exerts pressure on the membrane and contributes to preventing the fluid stream from exiting through the outlet;
positioning the positional member in a second position wherein the first flow channel has ceased to flow into the control chamber and the fluid stream exits as a second flow channel through the outlet via an exit outlet defined in an exterior of the sealing cylinder; and
moving the membrane distally from the inlet, when the anchor is in the positional member second position, such that the sealing chamber moves to block the second flow channel and opens a main valve seat to allow the fluid stream to exit from the inlet to the outlet as a third flow channel.

14. The method of claim 13, further including positioning a filter at the proximal end of the sealing chamber such that when the third flow channel is flowing, the third flow channel removes debris from the filter.

15. The water valve of claim 13, wherein the membrane repositions by flexing distally away from the inlet.

16. The water valve of claim 13, wherein the positional member moves from the first position to second position by being displaced by an electromagnet.

17. The water valve of claim 1, wherein the anchor engages a spring.
